(19) United States
(12) Patent Application Publication
(10) Pub. No.: US 2007/0009872 A1
(43) Pub. Date: Jan. 11, 2007

(54) System and method for teaching

(76) Inventors: John O. Sonsteng, St. Paul, MN (US); Heidi E. Harvey, Waltham, MA (US)

Correspondence Address: ROBERT PLOTKIN, PC, 91 MAIN STREET, SUITE 204, CONCORD, MA, 01742-2527, US

(21) Appl. No.: 11/471,985

(22) Filed: Jun. 21, 2006

Related U.S. Application Data
(60) Provisional application No. 60/692,518, filed on Jun. 21, 2005.

(51) Int. Cl. G09B 3/00

(52) U.S. Cl. 434/350

(57) ABSTRACT

Techniques are disclosed for teaching and learning about the substance of law, the doctrine of law, and the substance of lawyering skills. The same techniques may be applied to fields other than law. Information related to a course is provided to one or more students in an electronic form, such as on a CD/DVD or over a network connection. Such information may, for example, be related to a practicum exercise (such as a mock trial) and include a variety of information related to that exercise, including source materials and links to commentary by faculty members. The course also includes Faculty Supervised Tutorial Studies (FSTS), which are based on interaction between students and faculty throughout the course. Testing and/or assessment may be performed during the FSTS and/or at the conclusion of the FSTS. The testing/assessment may be conducted, for example, online through a written analysis or through a series of questions.

### CROSS REFERENCE TO RELATED APPLICATIONS

This application claims the benefit of U.S. Provisional Patent Application Ser. No. 60/692,518, filed on Jun. 21, 2005, entitled “System and Method for Teaching,” which is hereby incorporated by reference.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

1. Field of the Invention

The present invention relates to educational techniques and, more particularly, to techniques for teaching using audiovisual presentations.

2. Related Art

The problem that most education systems face today is one of limitations, due in part to tradition, economics and scheduling factors. Classroom time is limited, and devoted primarily to giving and providing information. In addition, student class sizes are ever-increasing in number. These problems seem to be ingrained in our higher education system.

Among the limitations sometimes found in conventional educational systems are:
Teachers do not recognize the multiplicity of learning styles or, if they are recognized, are unable, given the time and physical limitations of the traditional classroom setting, to address multiple learning styles or accommodate them in a way that maximizes the individual learning of each participant.
Students are tested infrequently and receive little day to day assessment feedback.
Students do not have the opportunity to apply their learning to practical applications or to learn and practice the skills necessary to implement their learning.
The talent and education of the teacher is wasted in that the time and physical constraints of the traditional classroom setting require the teacher to spend most of his or her time giving lectures that convey information, which are often the same or very similar lectures that the teacher has given to previous classes. As a result, teachers become burned out by the repetitive nature of the basic lecture information and frustrated by the lack of time to work with students to raise their level of understanding.
There is no assurance that the student has even a basic grasp of the information before coming to class.
It is difficult to know if the student has prepared for class.
The classrooms are designed primarily for students to learn information through their ears—often transferring it to notes—which is the least efficient way of acquiring and retaining information.
The students do not get hear the information more than one time.
Small group discussions and interchange of ideas is limited.
Large classes with one teacher make more dollars for for-profit endeavors or alternatively, cost less for not-for-profit endeavors.
Fifty minute classes in a 14-week semester are designed to maximize use of classroom space, teaching staff, and physical plant, not learning.

The powerful learning and teaching tools available to teachers are not being used in a way to reach their maximum potential. Online education often merely replicates a lecture system. Many teachers are afraid of using online education because they believe it replaces their classroom teaching experience. Teachers often believe they will be replaced in the classroom with the use of “distance learning.”

### SUMMARY

Techniques are disclosed for teaching and learning about the substance of law, the doctrine of law, and the substance of lawyering skills. The same techniques may be applied to fields other than law and are especially applicable to fields which require for their mastery both the acquisition of knowledge and the practical application of that knowledge in a set of skills, e.g., playing a musical instrument, participating in a sport, developing a medical diagnosis. Information related to a course is provided to one or more students in an electronic form, such as on a CD/DVD or over a network connection. Such information may, for example, be related to a practicum exercise (such as a mock trial) and include a variety of information related to that exercise, including source materials and links to commentary by faculty members. The course also includes Faculty Supervised Tutorial Studies (FSTS), which are based on interaction between students and faculty throughout the course. Testing and/or assessment may be performed during the FSTS and/or at the conclusion of the FSTS. The testing/assessment may be conducted, for example, online through a written analysis or through a series of questions.

### BRIEF DESCRIPTION OF THE DRAWINGS

FIG. 1 is a flowchart of a main learning highway and associated pathways that are used for teaching and learning according to one embodiment of the present invention; and

FIGS. 2A-2X are diagrams of display screens used to interact with a student according to one embodiment of the present invention;

### DETAILED DESCRIPTION

Embodiments of the present invention are directed to techniques for teaching the substance of law, the doctrine of law, and the substance of lawyering skills. The techniques disclosed herein, however, may be applied to subjects other than law.

Techniques disclosed herein release teachers from having to provide information in class, and permit teachers to teach students at a higher level. These techniques suggests that one- or two-hour blocks of time, which generally are scheduled for convenience of administrators, may not be the most effective way of engaging students in real learning. Surely Socrates never rang the bell every fifty minutes. As Socrates sat on the lawn with five or six students debating and discussing philosophical issues, he did not let his classes be governed by the clock or the sundial. Rather than replicate classroom teaching, the techniques disclosed herein build on such teaching and adapt it to the capabilities of digital technology.

Techniques disclosed herein may be used in a variety of situations. For example:
The techniques disclosed herein may be used as purely educational tools to be used by the learner, solely on the learner's own time without interaction with a teacher.
Faculty interaction may range from basic to complex. The techniques disclosed herein may, for example, be used by anyone from a beginning law student to an experienced attorney.
The learner may interact from the beginning with faculty through electronic media, telephone, mail, or fax communications. Such communication may, for example, be individual or in groups. The faculty communication may be scheduled at specific times for attorneys or students.
The techniques may include assessment and/or testing of the learner. Following a specific topic, for example in an Advocacy course, knowledge of a skill set such as direct and opening statements, may be tested based on, for example: a student's written analysis of a problem, through short answer/multiple choice tests, and on the student's performance of a skill.

The techniques for teaching and learning disclosed herein incorporate the best of adult learning theory by addressing the six essential elements of successful education (as described by Leonard H. Clark & Irving S. Starr, Secondary and Middle School Teaching Methods 54, 87, 38, 86, 175 (5^{th} ed. 1986); Mark S. Caldwell, Educational Architecture: Constructing Course to Meet Learner's Needs and Expectations, 11 J. Prof. Legal Educ. 1, 4 (1994)):
Objectives
Reinforcement and feedback
Positive learning environment
Active classroom
Learning styles
Lesson cycle

Examples of ways in which each of these elements may be implemented will now be described in more detail.

Objectives: Cognitive domain objective levels may be incorporated into the methods of teaching and learning disclosed herein. For example, from simple to complex, the objective levels may include:
Knowledge: On this level one knows a contract requires an offer and acceptance, but may not necessarily understand why.
Comprehension: On this level of the cognitive process, one knows what an offer and acceptance are and why each is necessary.
Application: On this level one can apply the learned knowledge to legal problem-solving. For instance, one can analyze behavior to determine if a contract exists or to draft a contract to fit a client's needs.
Analysis: On this level one can break down complex ideas, see relationships, understand cause and effect and thereby come to a more sophisticated understanding.
Synthesis: On this level, the most creative, one can put old ideas or previously learned knowledge together to come up with new ideas or concepts.
Evaluation: On this level one can place judgment on something based on one's understanding of it and its ideal. Evaluation is the highest level because it depends upon a complete understanding.

Lesson Cycle: A planned lesson which incorporates the educational theories involving objectives, reinforcement, positive learning environment, activity and learning styles. (See Clark, supra note 12, at 175-76.)
Anticipatory Set: A statement or proposal which “[increases] the student's interest in and motivation to learn the material.” Hopefully in college level and graduate level courses the anticipatory set is already present in the student.
Objective: The desired learning outcome and clear communication of that objective to the students.
Input: Method of instructing or informing.
Modeling: Method of demonstrating the task to accommodate different learning styles and ensure proper understanding. According to Hunter, modeling is not simply going through the motions, but demonstrating the task with a verbal description of what the students should do.
Check for Understanding: Ask questions of the students and create a positive learning environment so that students will not refrain from participating for fear of asking a “dumb” questions.
Guided Practice: Supervise the students as they first attempt the task.
Independent Practice: Give independent practice (sometimes known as homework) so as to evaluate student's mastery. (Sprinthall, Norman & Sprinthall, Richard, Educational Psychology: A Developmental Approach, 4^{th} Ed., 316-32, McGraw-Hill (1987).)

Techniques disclosed herein may follow a planned lesson cycle. Such a cycle may, for example, be implemented as follows for a particular topic, such as an opening statement in a trial. Learning objectives may be set forth in writing and on a computer-readable medium (such as a CD or DVD) provided to the student. The CD/DVD may provide input and modeling by providing a creative method of instruction and modeling on specific topics of law, substance of law, and legal skills. Testing/assessment, guided practice, and independent practice may be achieved by providing feedback and assessment of each of the following: a generally written analysis of the learner's skill sets, a specific written analysis of a focused skill set based on a practicum exercise, a performance of a skill, and repetition of a focused skill set (e.g., written and oral exercises). The learning cycle just described may then be repeated for additional topics (such as direct and cross examination) until all skill sets have been completed.

Another aspect of the present invention is directed to Faculty Supervised Tutorial Studies (FSTS). FSTS are based on interaction between students and faculty at all stages of the course. Testing/assessment may be performed during the FSTS and/or at the conclusion of the FSTS. The testing/assessment may be conducted, for example, online through a written analysis or through a series of questions.

In one embodiment of the present invention, FSTS are provided using a computer-readable medium (such as a CD and/or DVD) and/or a network communications channel (such as the Internet). The materials provided through such media are designed to provide a main learning highway with links to specialized learning pathways.

A course may include an introduction to the course educational model and learning objectives framed by the main teacher. The introduction may, for example, be an inspirational lecture by an authority in the relevant field. The introduction need not be performed by the classroom teacher.

A course may also include one or more “mini-lectures” by a teacher. Such mini-lectures may be short and focused on a specific area. Such mini-lectures may be followed by audiovisual presentations (e.g., PowerPoint presentations) and repeated. The student may read and/or hear the presentation.

Specific learning objectives may be stated in the mini-lectures in measurable terms, such as:
“At the end of this session you will be able to demonstrate your understanding and competence in [name skill].”
“You will demonstrate the skill in the following ways: [e.g., writing, oral presentation, video tape test].”

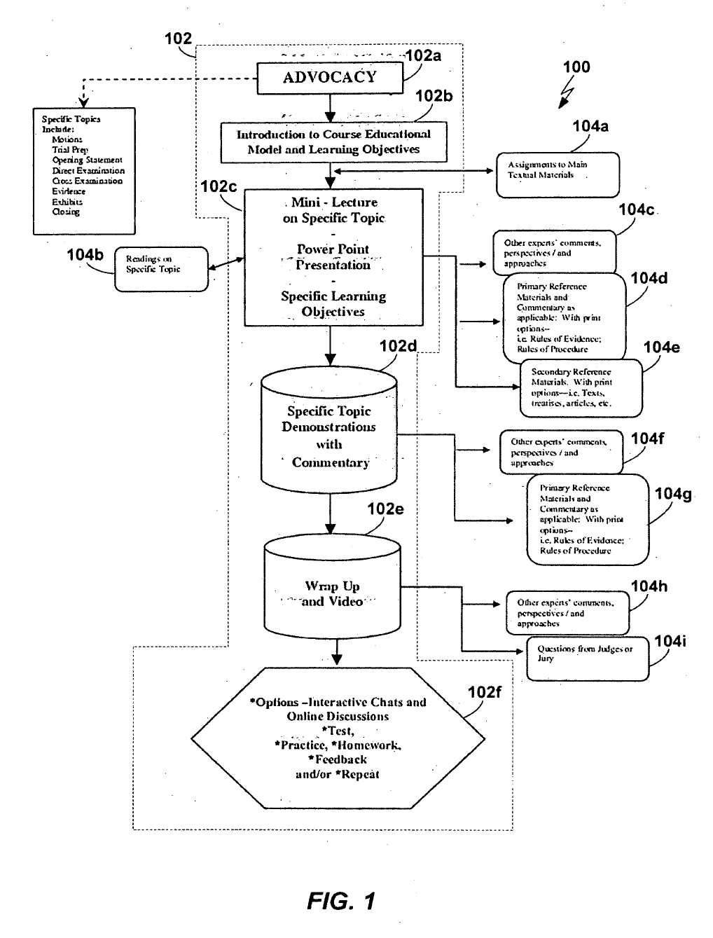

Along the “learning highway” there may be a series of links, or paths, that the students may access. For example, referring to FIG. 1, a flowchart 100 is shown illustrating a main learning highway 102 and a plurality of links (paths) 104a-i off of the learning highway that the students may access. The students may use the main learning highway 102 and the links 104a-i in any of a variety of ways. Although FIG. 1 illustrates a highway 102 and pathways 104a-i for teaching trial advocacy, the techniques disclosed with respect to FIG. 1 may be applied to any topic. For example, with reference to teaching advocacy, the learning highway can easily be configured to place the participant in the role of advocate (all pathways and links and events are turned “on” reflecting the responsibility of the advocate to consider all the factual, legal, procedural and rhetorical issues that may arise), the judge (pathways and links involving the conduct of the trial and the rulings that occur at trial are turned “on”, while the links relating to developing and presenting the advocate's positions are turned “off,” or in the position of the jury with only links relating to the actual presentation of trial argument and evidence turned “on.” As such, the particular invention is also useful as a method for modeling trial presentations, for purposes of practice, focus group study, jury modeling, jury selection, and obtaining reactions of judges and juries to trial presentation, as well as a method for training advocates or judges.

For example, the students may traverse the entire learning highway 102 straight through in the illustrated sequence: from the introduction 102b to the mini-lecture(s) 102c, to the specific topic demonstrations with commentary 102d, to the wrap up and video 102e.

The students, if they so choose, may follow links to other paths, such as:
After the introduction 102b, the students may optionally follow the link to assignments to main textual materials 104a.
During the mini-lecture 102c, the students may follow links to:
   Readings on the specific topic covered by the mini lecture 104b.
   Other experts' comments, perspectives and approaches 104c.
   Other primary reference materials and commentary (e.g., Rules of Evidence; Rules of Procedure) 104d.
   Secondary reference materials (e.g., textbooks, treatises, and articles).
During the specific topic demonstration 102d, the students may follow links to:
   Other experts' comments, perspectives and approaches 104f.
   Other primary reference materials and commentary 104g.
During the wrap up and video 102e, the students may follow links to:
   Other experts' comments, perspectives, and approaches 104h.
   Questions from judges or jury 104i.

Note that the particular main learning highway 102 and links 104a-i shown in FIG. 1 are merely examples and do not constitute limitations of the present invention. Other main learning highways and links are consistent with the present invention.

The main learning highway 102 may be presented to the students in any of a variety of ways. For example, in one embodiment of the present invention, the main learning highway is recorded as an audiovisual presentation in an appropriate digital format, and by default is played to the student in the sequence shown in FIG. 1. The highway 102 may be presented using a device and/or software that allows the student to pause, rewind, fast forward, and otherwise move within the highway 102 as desired. The teacher or other author of the highway 102 may, however, impose limitations on the ability of the student to change the presentation of the main learning highway 102. For example, the teacher may prohibit the student from skipping the introduction 102b due to its importance.

The student may explore the pathways 104a-i in any of a variety of ways. For example, and as will be described in more detail below, the presentation of the main learning highway 102 may include hypertext links which the student may select. (such as by clicking on them with a mouse) to follow the links to the associated material. Other forms of user input may be implemented to enable the student to access the pathways 104a-i. When the student follows a link, the associated material may be presented to the student. The student may then return to the main learning highway 102. Software controls such as those present in a web browser may be used to allow the user to navigate through the main learning highway 102 and associated pathways 104a-i.

The additional links or paths method permits the primary teacher to have access to the best teachers nationally and internationally who will give their perspectives on a subject. For this method, short lectures and commentary by experienced judges, lawyers, philosophers, other teachers, scientists (depending on the subject matter) and other professors in the area may provide different viewpoints on the subject matter, giving the student a much broader base of knowledge from which they can draw.

The course may also provide students with audiovisual demonstrations and analysis of issues, solutions to problems in law, legal philosophy, or skills. Such demonstrations may, for example, contain:
Still photographs of the person lecturing and of the demonstration. The people involved in the demonstration may be photographed and shown on one of the screens, thereby setting the scene. Such photos may change periodically (e.g., every few seconds). The photos are important as they permit us to demonstrate a diverse group of people in the action to assist demonstration relevance to the audience. Through the use of photography and demonstrations, diversity may be achieved by putting varieties of people in situations of power, rather than having to worry about finding someone of a particular age, gender or ethnicity who has the ability and availability to act as a lawyer or as a participant.
The transcript of what is being said. For example, video or still photos of the demonstration may appear on one side of the screen, while the transcript may appear on the other side of the screen.

These learning highway specific topic demonstrations may be designed not to be full-motion video for at least two reasons:
The cost of obtaining high-quality performances from human actors can be prohibitive.
Videos typically cannot be edited without scheduling significant amounts of time in a television studio.

As a result, performances/demonstrations need not, buy may be, live video.

Studies have shown that when people both see and hear something, they learn faster and retain more than if they just see or hear it individually. The student may also go back again and again and review areas that they did not understand the first time. The student may print materials on topics and rules of interest.

The course may also provide students with links and paths to other situations that are similar and to other ways problems have been solved. During the performance, the teacher may enter the demonstration and discuss what occurred and what is coming next.

Since these demonstrations need not be live, they may be prepared in advance. Actors may read from scripts rather than memorizing lines, and editing may be performed with much higher quality than for the same priced full action video performance. Production of still photos with accompanying audio only requires a sound studio, rather than a video studio in the case of full-motion video.

The course may conclude with a wrap-up video that repeats the specific topic/subject the student has learned. If the students are not sure whether they have achieved sufficient comprehension, they may go back through some or all of the course again.

The wrap-up video may, for example, be full-action video or still photographs, along with other expert's comments and perspectives. In some areas there might be questions or considerations that people outside the teaching group may have considered—for instance in a trial, there may be questions from judges or jurors, or from philosophers (political, religious, moral, etc.).

At the end of the FSTS, the teacher may test/assess the student. The medium on which the course is provided may, for example, provide test/assessment tools. For example, if the course if provided on a CD, the CD may include assignments for the student to perform. Such assignments may include mechanisms for providing automated feedback to the student.

In order to assure consistency, assessment/testing forms provide measurable assessment and feedback to assist in skill set development through both written and oral exercises. The assessment forms may be online to provide immediate feedback and recording of the valuation criteria. An assessment form for an opening statement may, for example, allow the teacher to provide assessments of the student's effective organization and structure, skill as a storyteller of facts, skill at explaining the theory of the case, ability to effectively use persuasive approaches and techniques, ability to effectively explain weaknesses in her case, ability to effectively deliver and present her case, and ability to avoid providing an objectionable and argumentative opening statement.

Once the student demonstrates a basic competency, the student may attend a face-to-face class for an interactive session on any of the topics, such as a skill, doctrine, or substance. Such an interactive session is referred to herein as an Intensive Residential Practicum (IRP). The teacher may assign projects in preparation for an IRP.

An IRP may be conducted in any of a variety of ways. Training sessions held by the National Institute for Trial Advocacy (NITA) are examples of IRPs, as are the Advanced Advocacy courses provided by William Mitchell College of Law.

IRPs may be of any length, depending on the learning objectives set out by the teacher. Students may, for example, receive feedback through video tape and testing. They may then come to a week-long advanced advocacy course to pull together everything they have learned. In a class that has residential sessions between the FSTS, the classes may, for example, be four or five hours long with small group discussions, debate, analysis, reporting and feedback. The courses may, for example, be a few hours long (e.g., in the case of direct examination, search and seizure, or search warrants for Criminal Law); or a week or more where students focus on their broader skill sets. In an Advocacy course, the mini-classes (2-4 hours) could cover all the skill sets, such as direct- and cross-examination, and a final trial or a week-long course. The entire face-to-face course may cover all the skill sets in an intense immersion extended course.

Following a set series of short Intensive Residential Practicums (IRPs), between which are the Faculty Supervised Tutorial Studies (FSTSs), students may be provided a more comprehensive testing situation based on the learning objectives of the course. For example, in the Advocacy courses the final test may be a trial or an arbitration in which the students get to pull together all the skills that they have learned throughout the course.

An example of a “practicum” is a real or fictional case file for use in teaching trial advocacy skills. A practicum exercise is the substance upon which a CD/DVD is built. Students may receive both hard copies of the exercise along with an accompanying DVD/CD that has all of the practicum exercise materials (e.g., main learning highway and associated pathways) on it.

A practicum exercise may include a wide variety of materials. For example, in a practicum exercise for a patent trial, the exercise material may include, for example: a description of the case (e.g., facts, procedural history, description of the parties), a planning guide and checklist, patents, prior art, expert witness statements, jury instructions, and the law (e.g., statutes and judicial opinions).

The materials in a practicum exercise may be real or fictional. For example, in a patent practicum, the patent(s) may be real patents or fictional ones devised for the exercise. Real and fictional materials may be mixed in a single practicum as desired.

The materials provided as part of a practicum exercise may also include the learning highway and pathways associated with the exercise (as shown, for example, in FIG. 1). All of these materials may be provided to each student on a computer-readable medium, such as a CD/DVD, or over a network connection. As a result, the digital materials provided to the student may incorporate a virtual tour of the court room and the minds of the participants and parties.

A practicum exercise may be used in any of a variety of ways, such as:
as part of a complete course in advocacy and may be combined with other exercises to add additional focused exercises;
as an entire trial (court or jury) which may cover liability and damages or be limited to one or the other.
for an expert examination.
for discrete exercises on damages or liability.
for the introduction of exhibits.
as a basis for a Markman hearing in a patent case.
for discovery (e.g., depositions or interrogatories).
for motion practice.

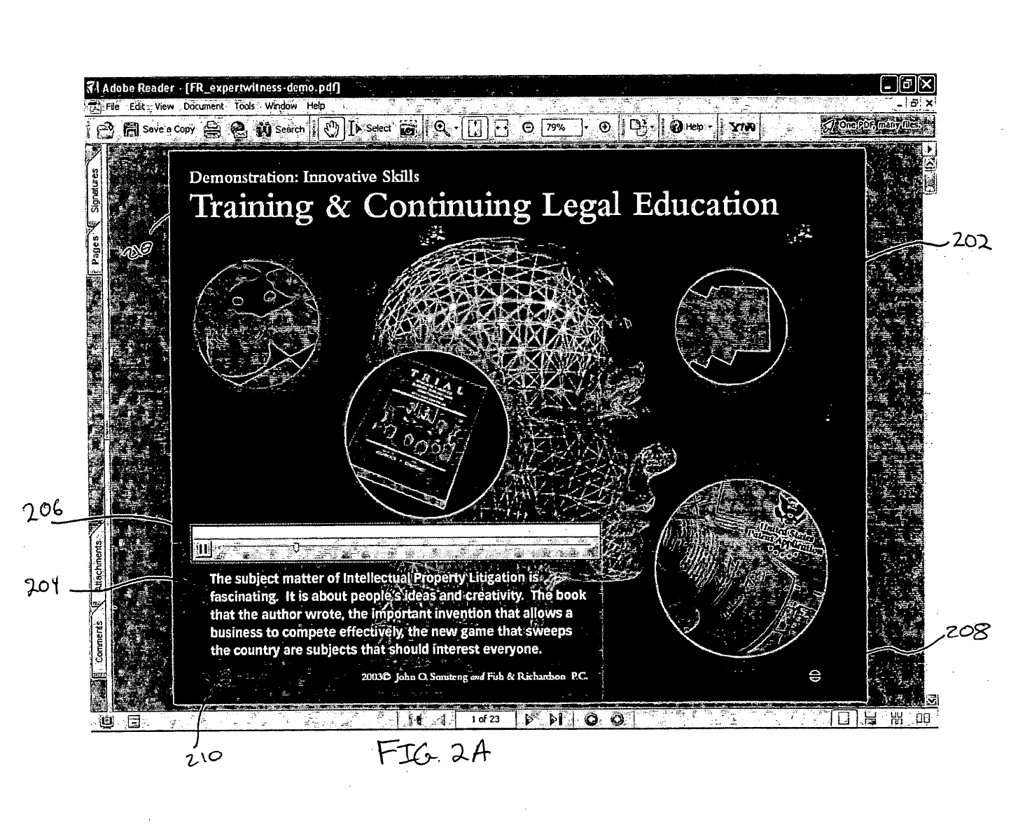

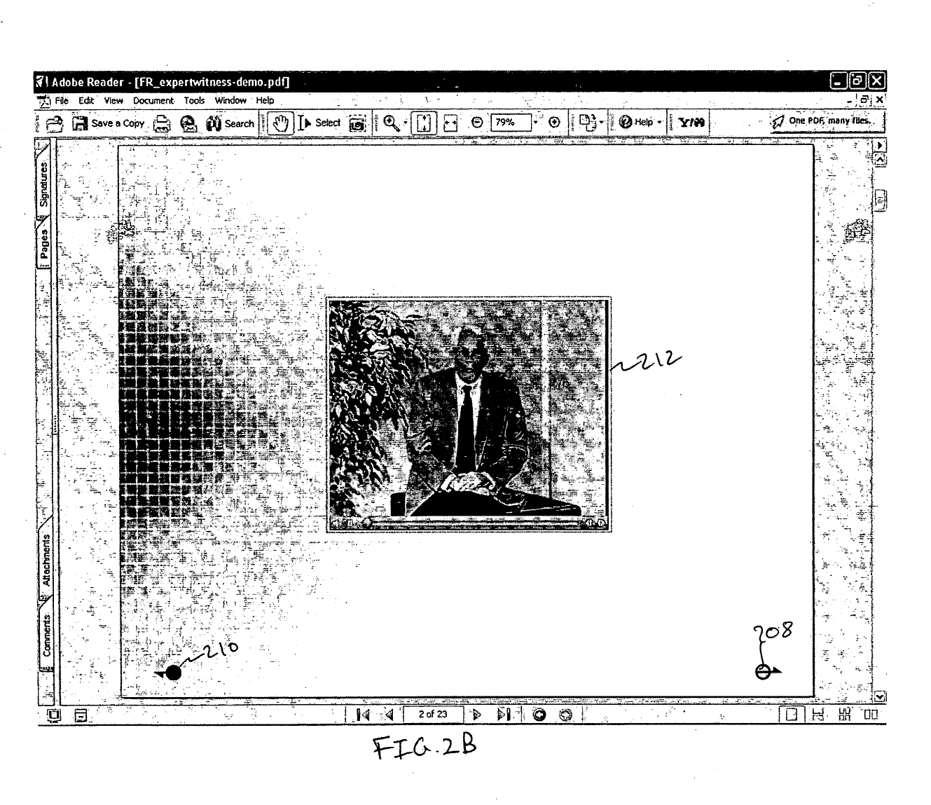

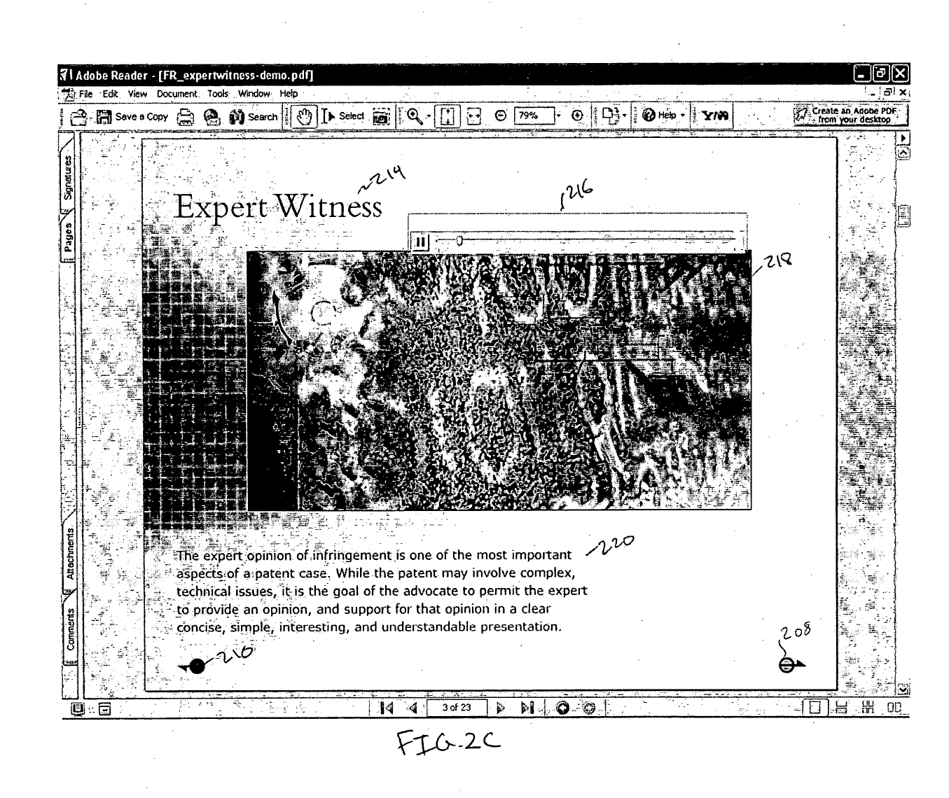

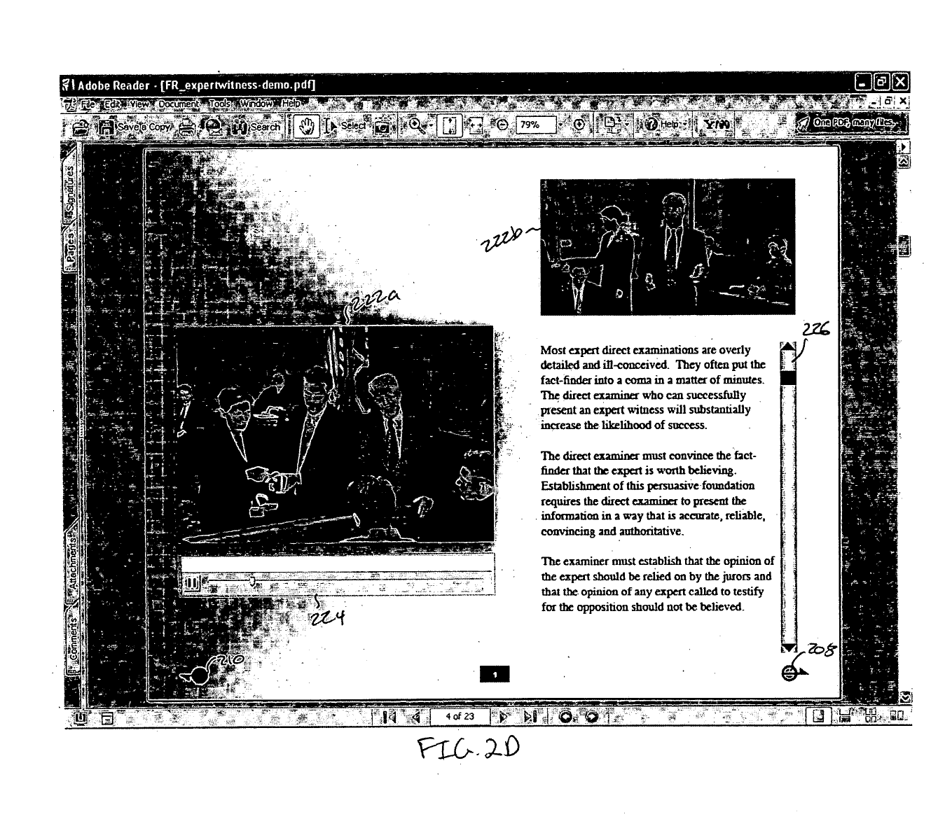

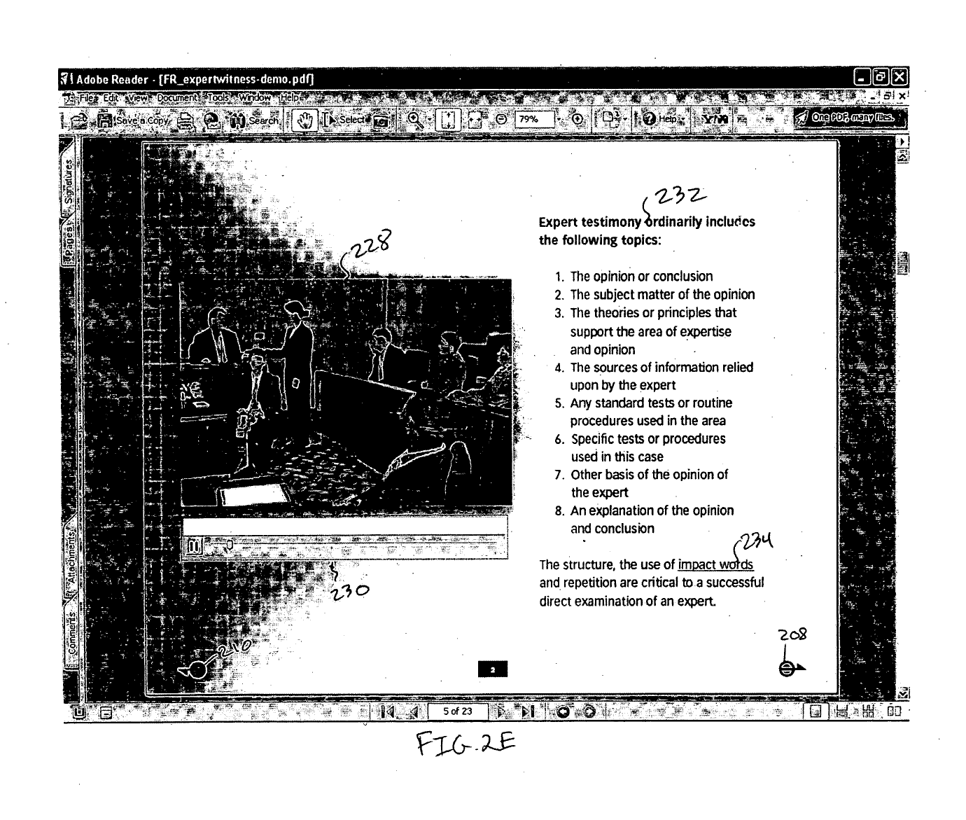

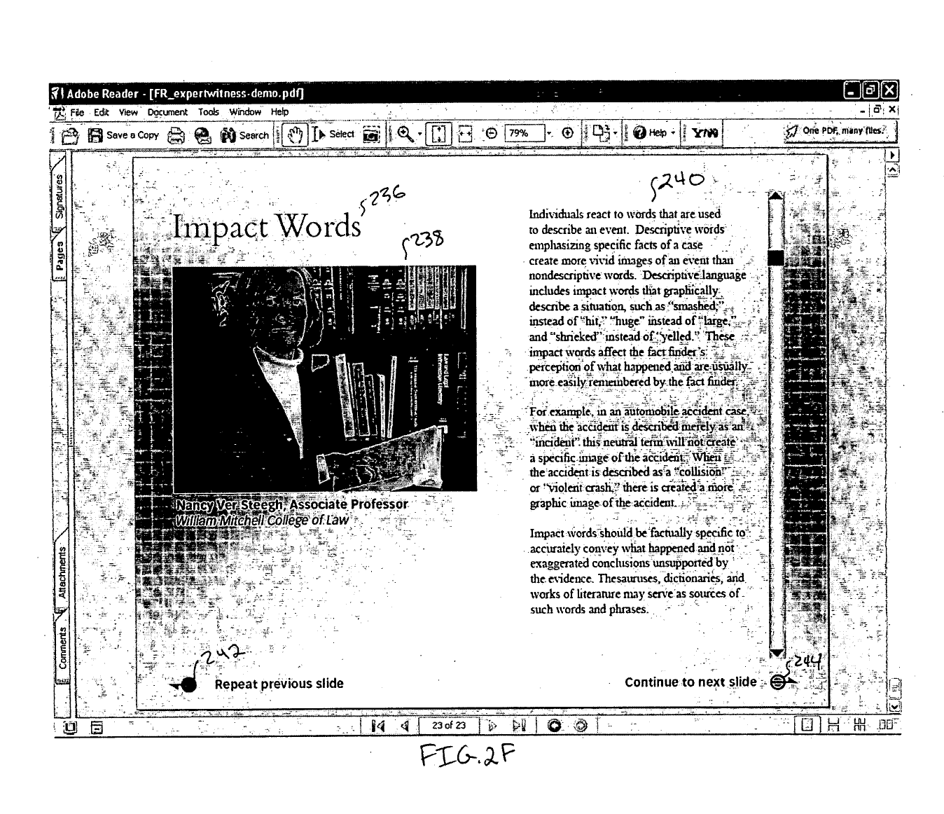

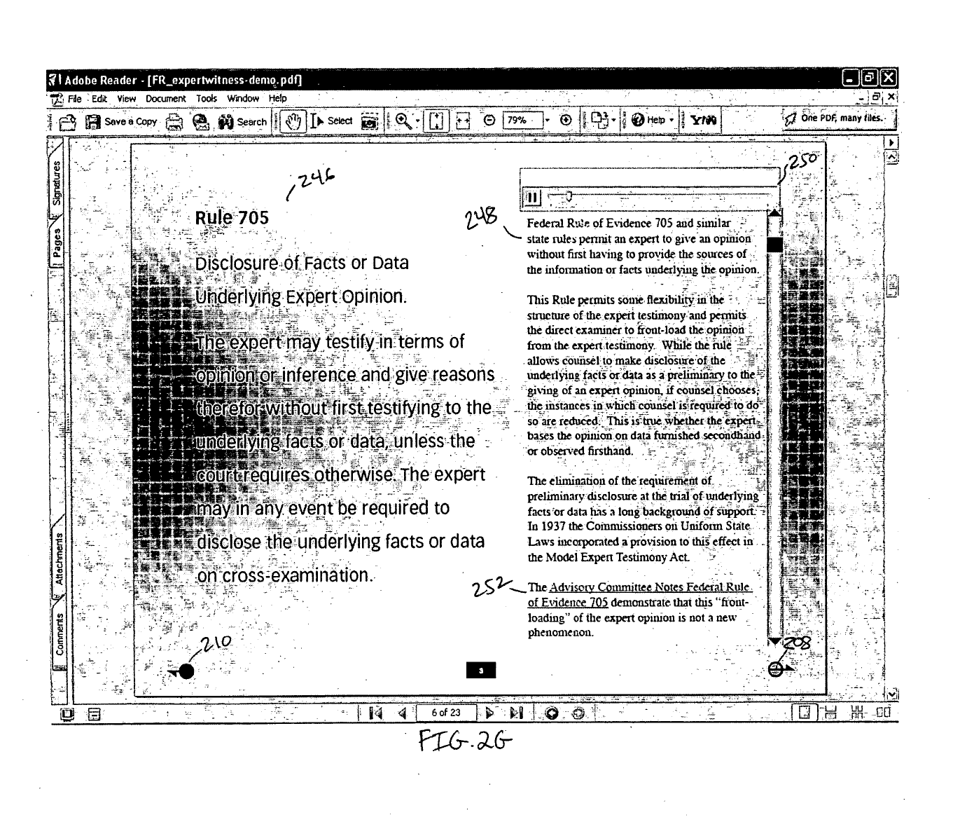

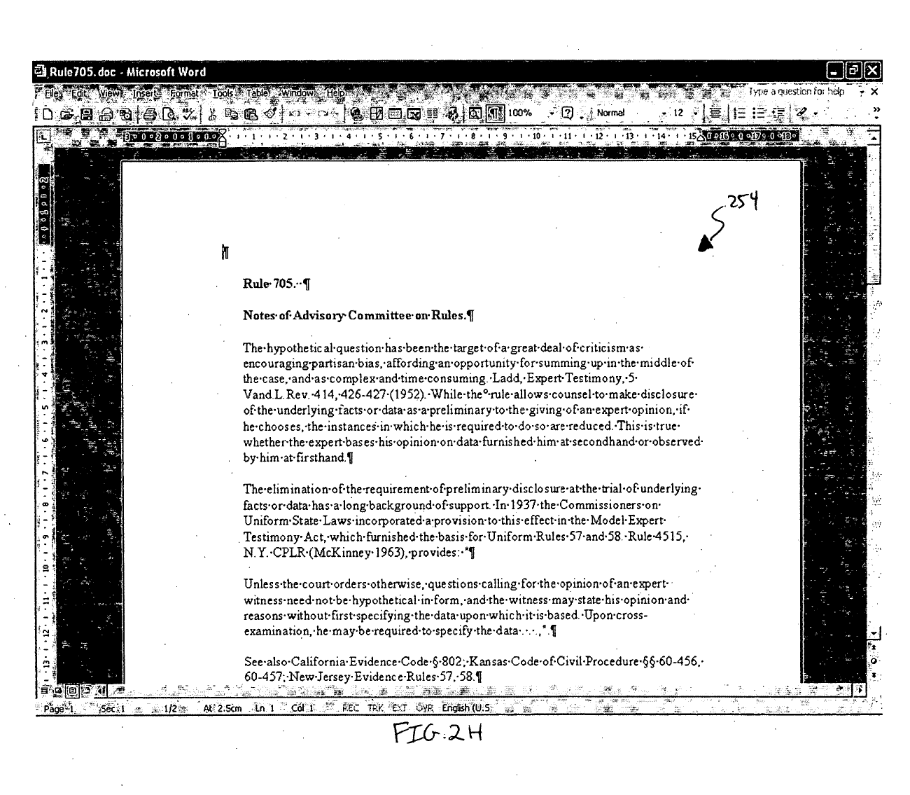

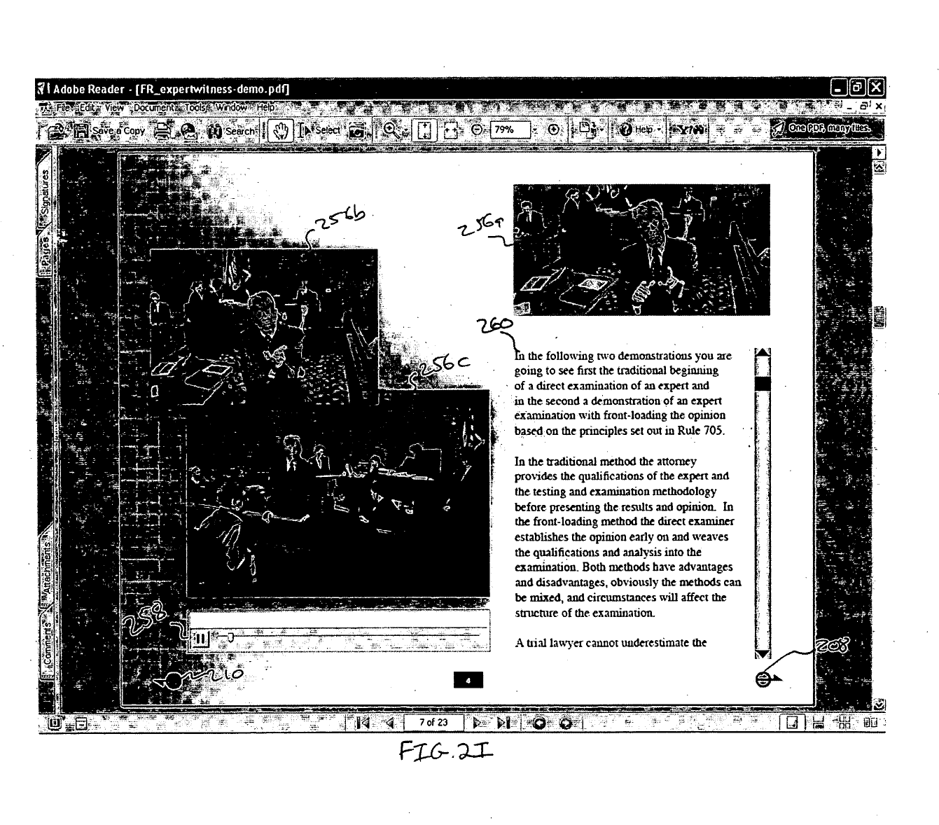

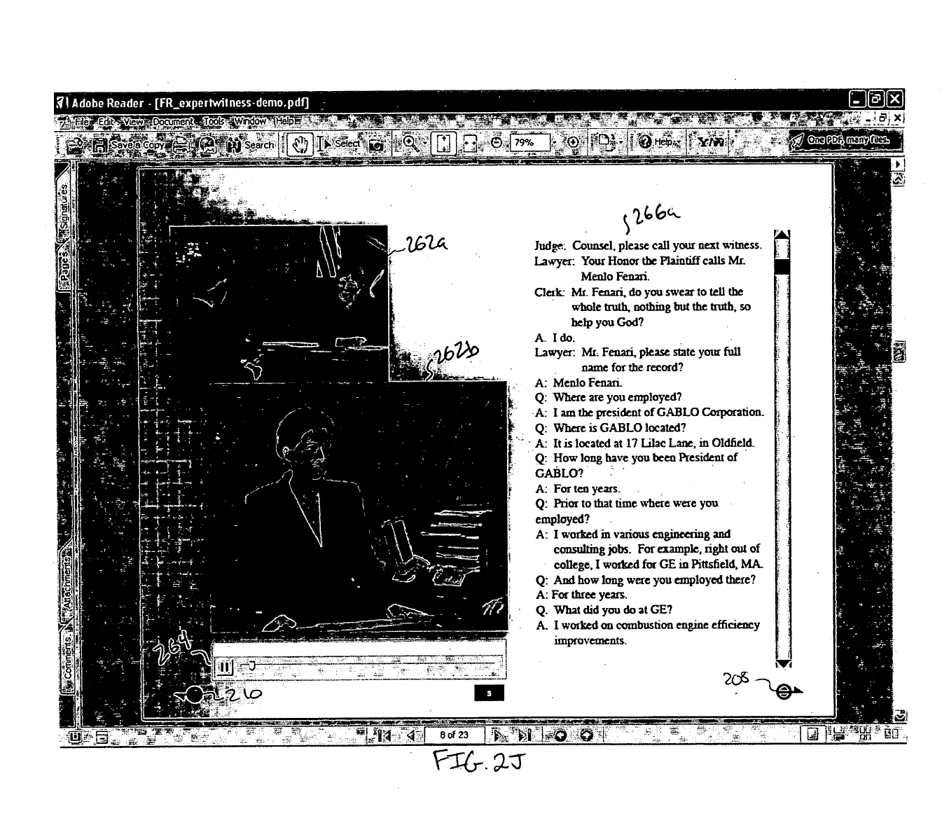

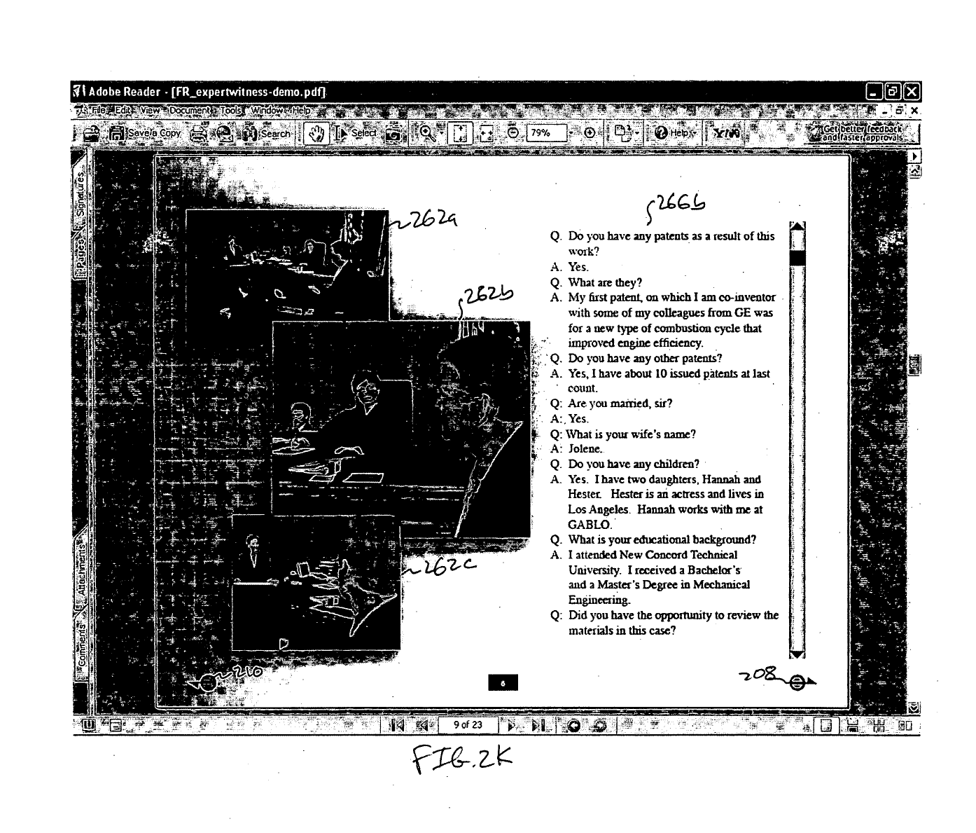

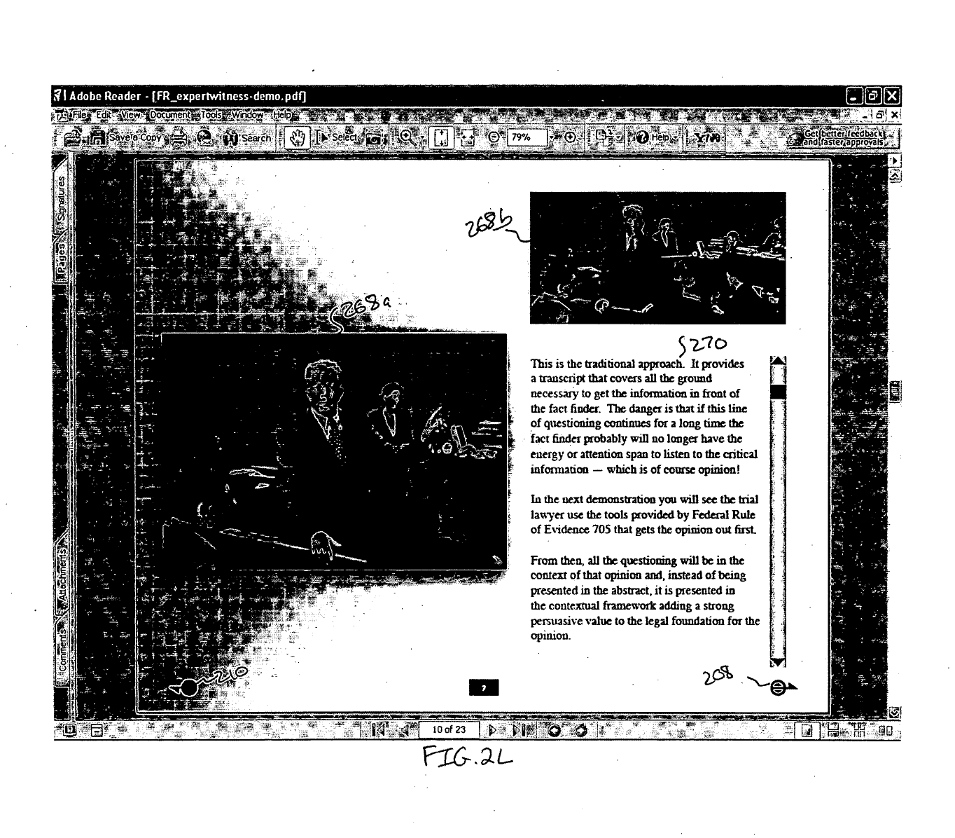

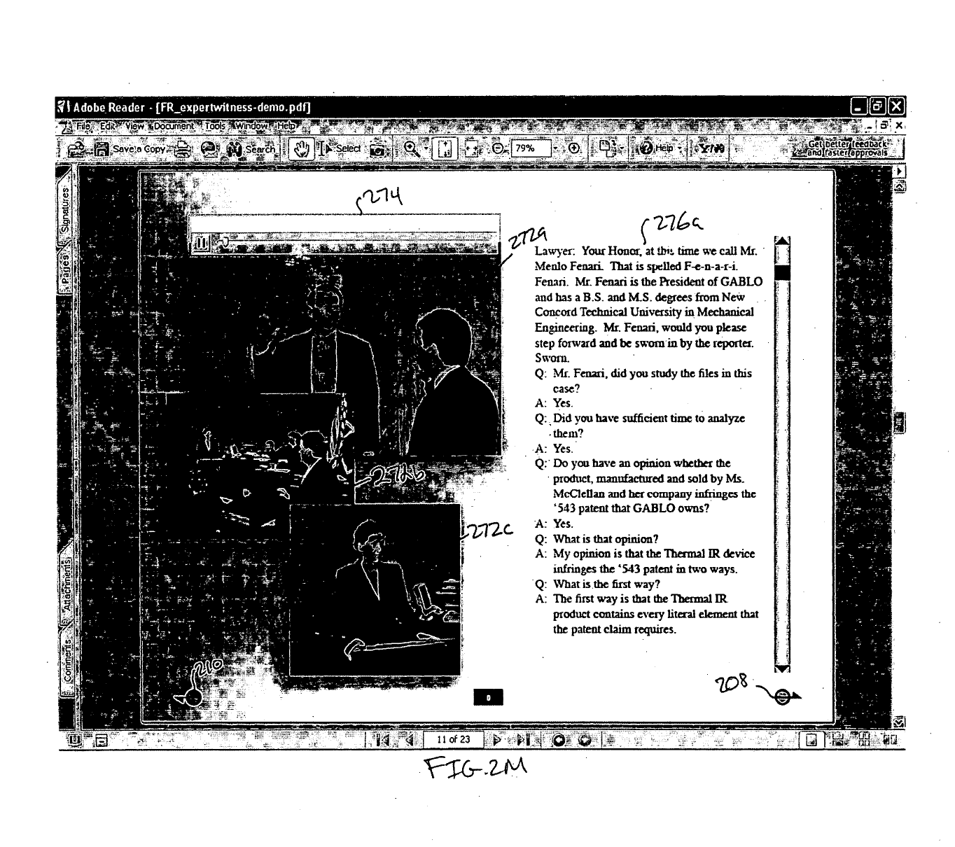

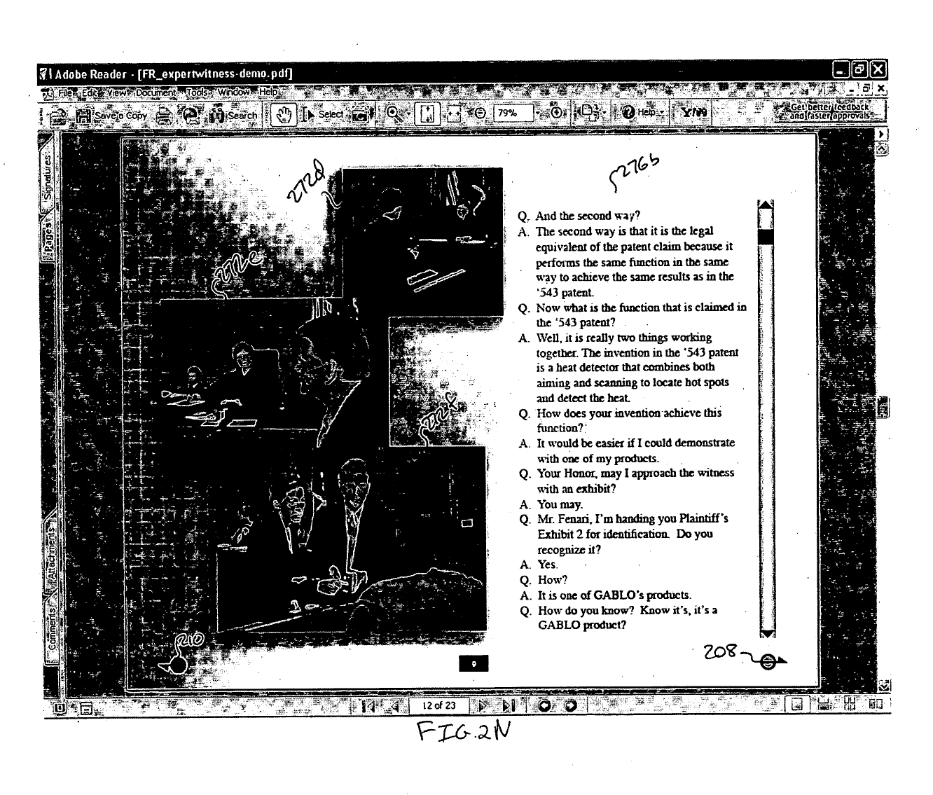

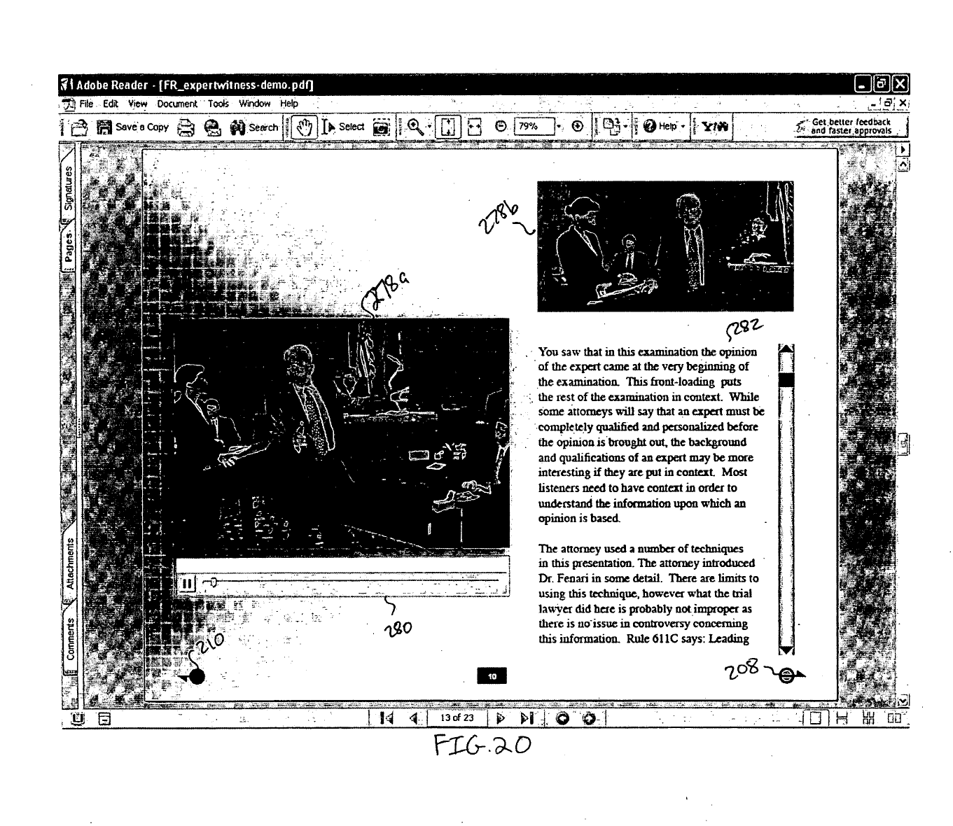

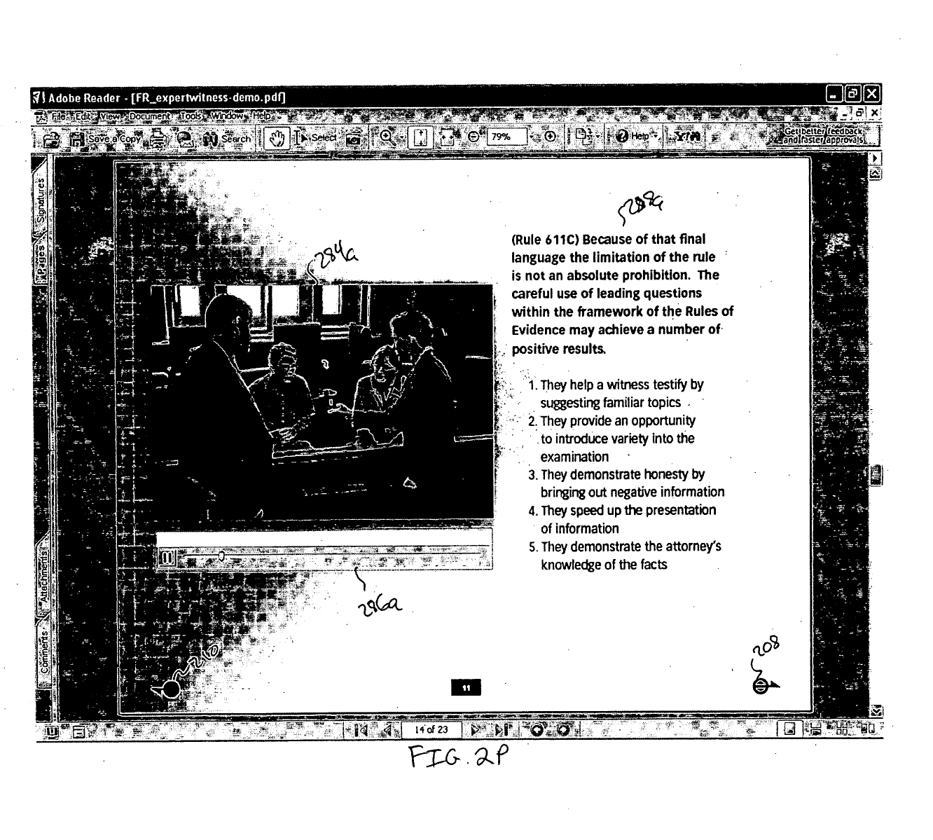

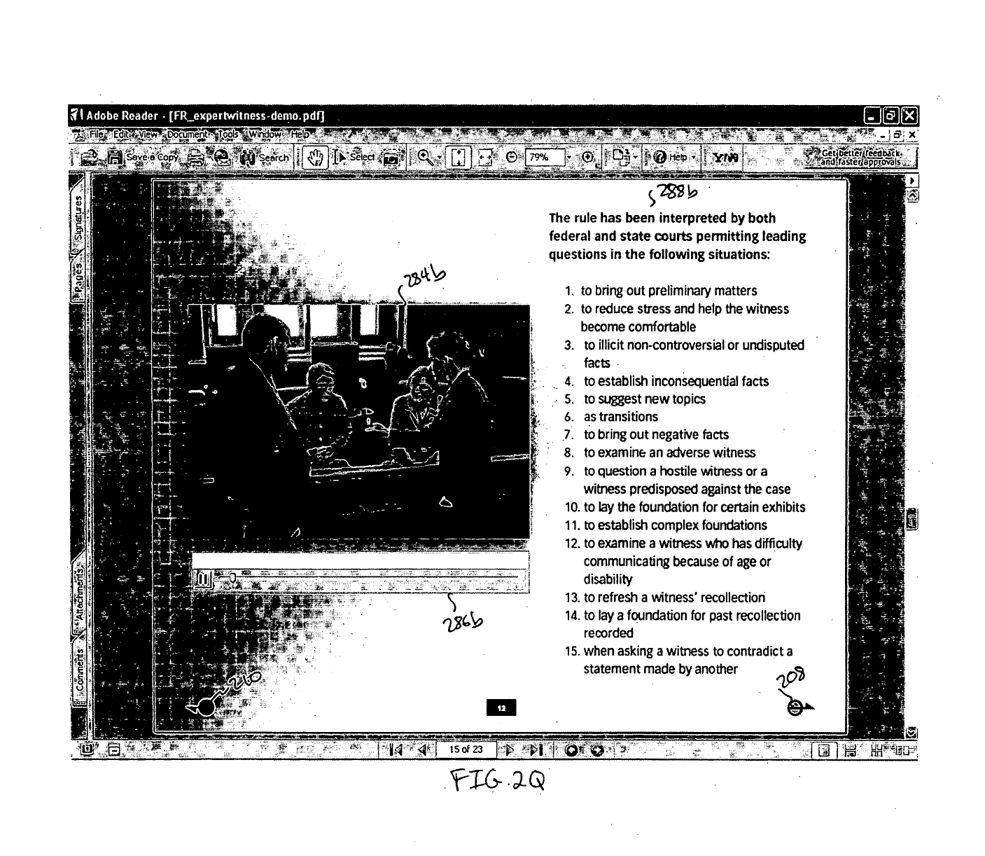

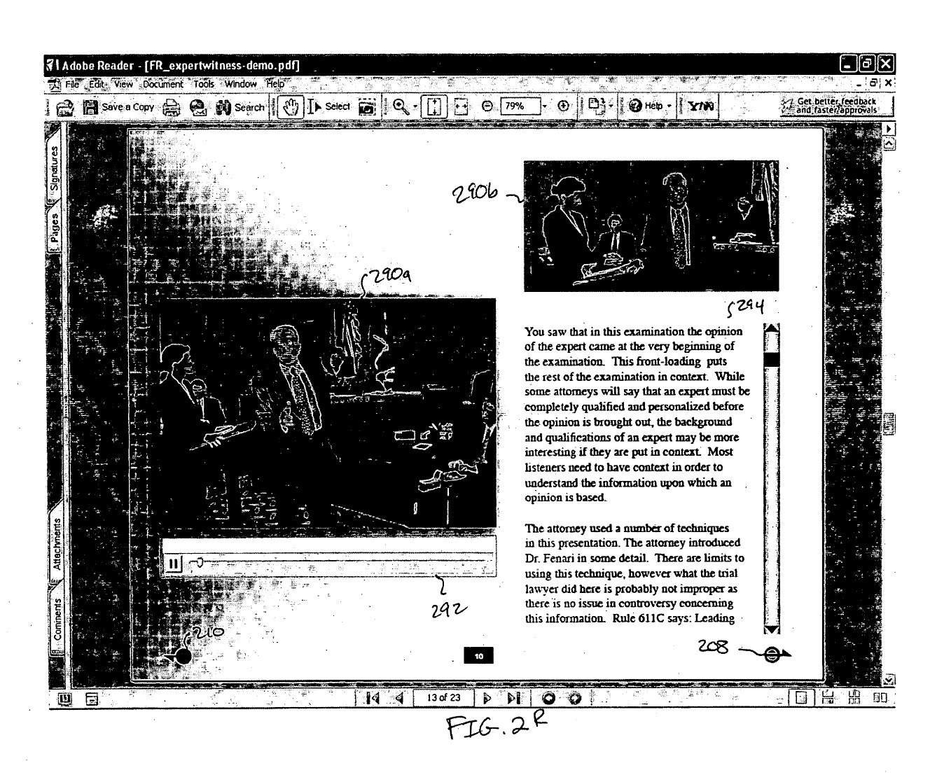

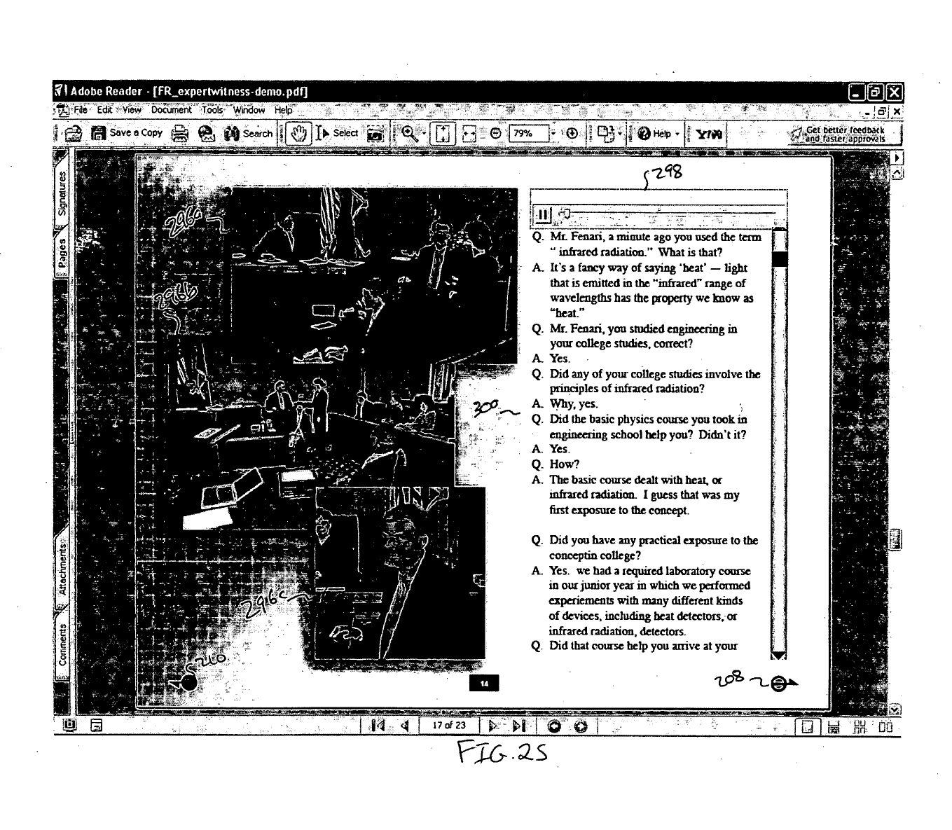

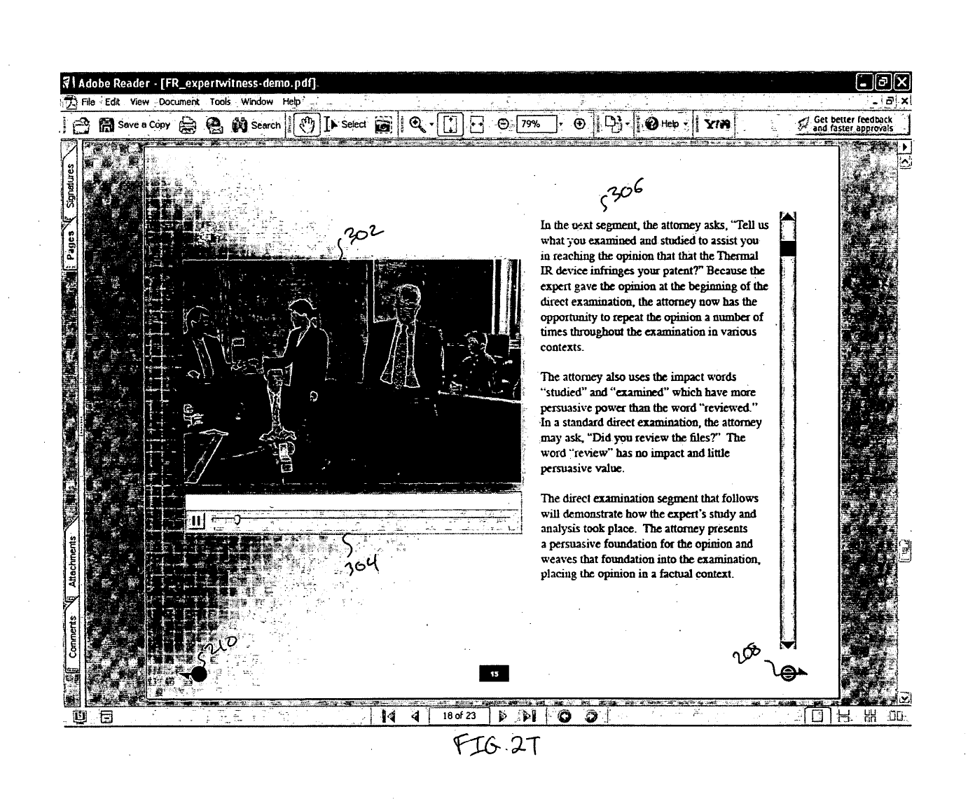

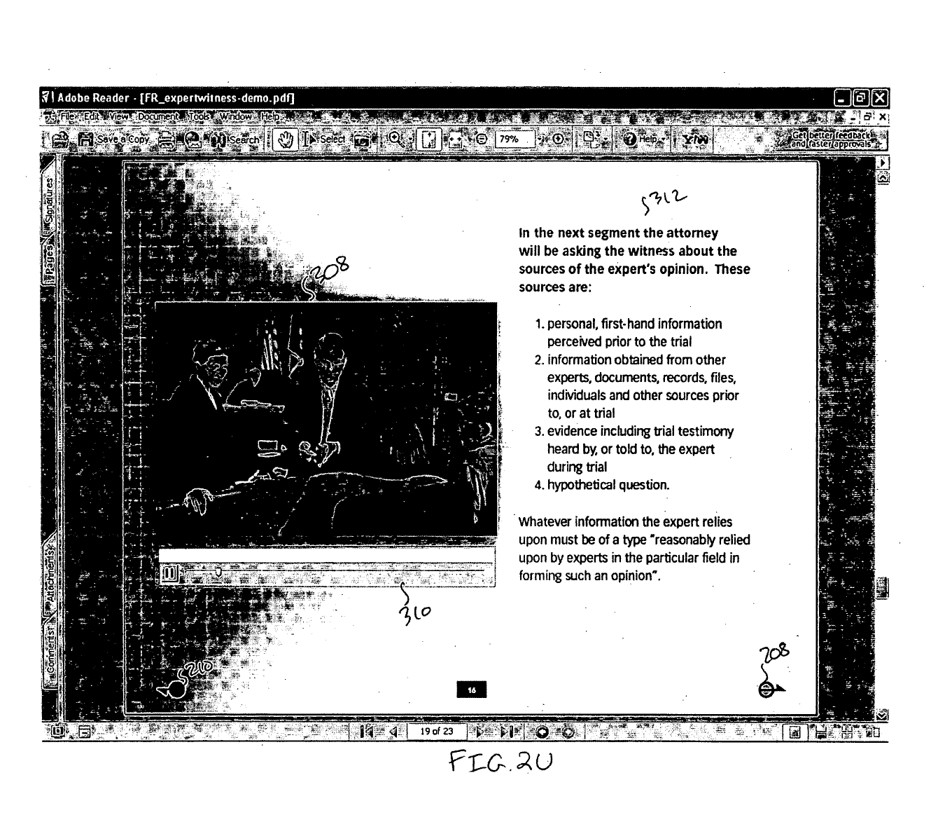

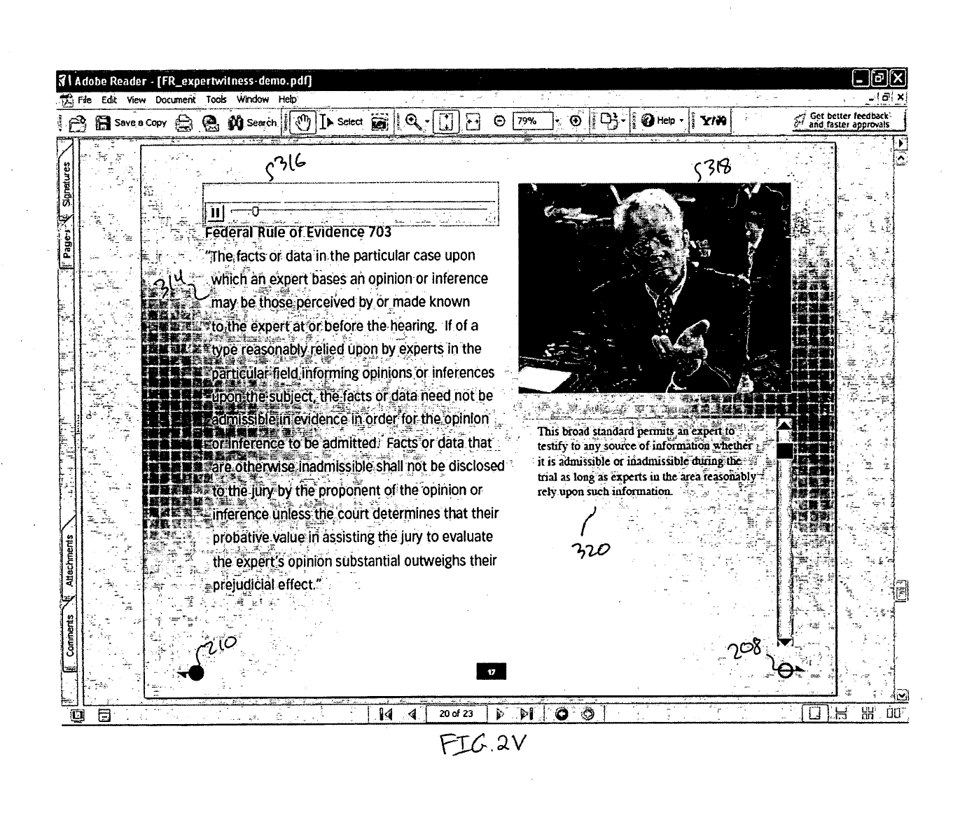

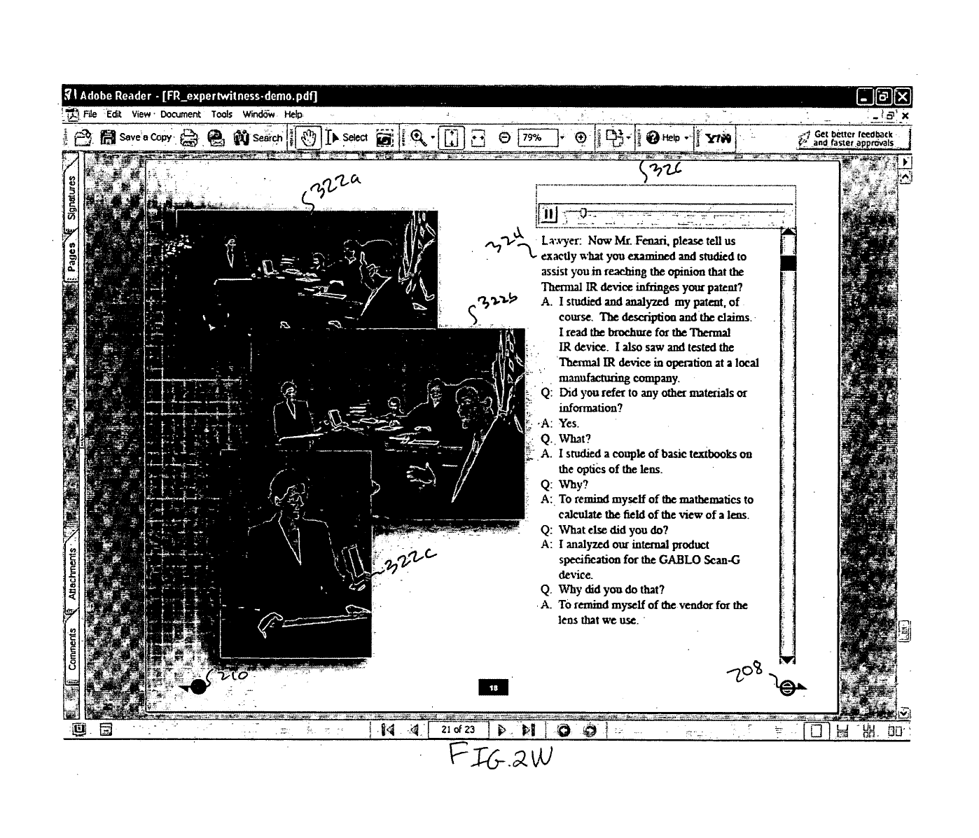

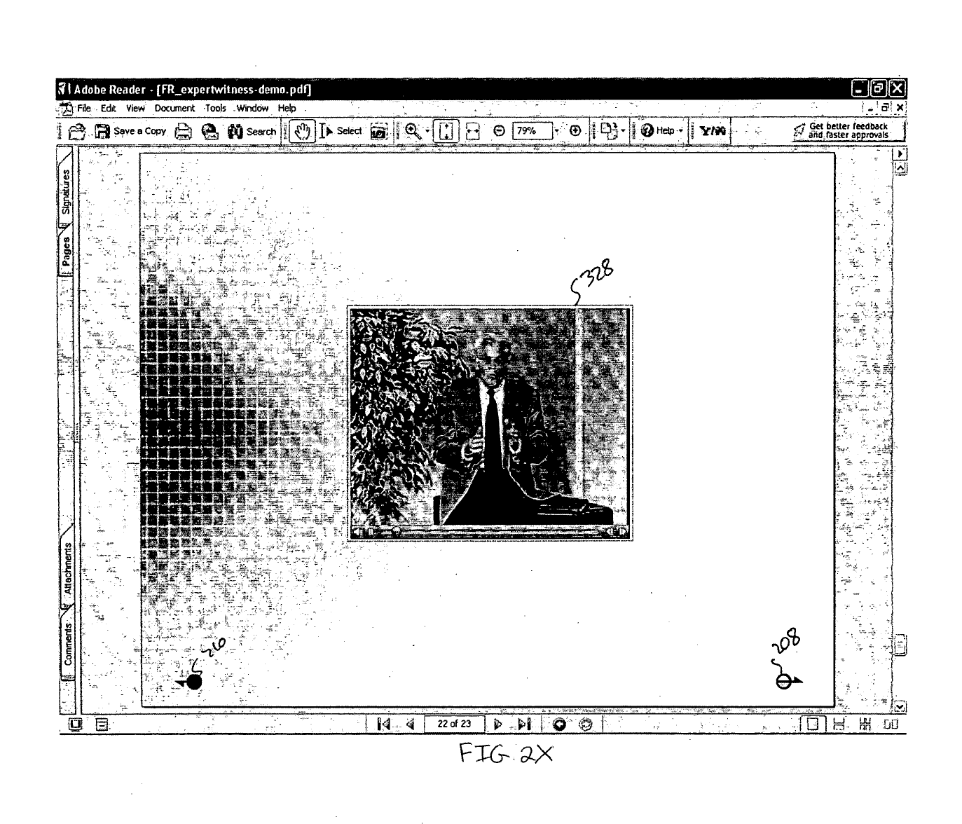

Referring to FIGS. 2A-2X (which may be referred to herein collectively as FIG. 2), diagrams are shown representing screen displays for use in a course according to one embodiment of the present invention. Although the example illustrated in FIG. 2 teaches skills used in a patent infringement trial, the same or similar techniques may be applied to teach other skills. The screen displays may, for example, be embodied in a multimedia document, such as an Adobe Portable Document Format (PDF) document including digital audio and video. When a user opens the document, an introductory screen such as that represented by FIG. 2A may be shown. The introductory screen may include a variety of elements, such as a title 210, a background graphic 202, introductory text 204, an audio control bar 206, a slide forward button 208, and a slide backward button 210.

The title 210 may be any title suitable for the subject matter taught in the course. The introductory text 204 provides a brief description of and/or introduction to the course. When the introductory screen in FIG. 2A is displayed, associated audio (which may, for example, be stored in digital audio files embedded in the same file as the screen displays or in separate files) may begin to play. Alternatively, the student may press a “play” button on the audio control 206 to begin playing the audio. The audio may be a spoken version of the introductory text 204. The student may press a “pause” button on the audio control 206 to pause the audio. Furthermore, the student may drag a slider on the audio control 206 to repeat any portion of the audio. As may be seen from the screen display illustrated in FIG. 2A, the course provides students with the opportunity to learn using a variety of learning styles by presenting information in written, graphical, and spoken forms. This screen display also serves the function of announcing the topic of the course, as described above with respect to step 102a of FIG. 1.

The student may click on the slide forward button 208 to advance to the next slide. Although in general the student may click on the slide backward button 210 to return to the previous slide, the slide backward button is inoperable in FIG. 2A because the screen shown in FIG. 2A is the first slide. The slide forward button 208 and slide backward button 210 provide the student with a degree of control over the pace and sequence in which the student receives information. The student may, for example, use the buttons 208 and 210 to skip forward to a subsequent slide, and to return to previously-viewed slides, and thereby to receive information and learn in a sequence other than the linear sequence in which the information is stored in the digital course file.

Referring to FIG. 2B, a second slide in the course is shown. This slide displays a single window of digital video 212 which may, for example, be stored in a digital video format such as the Apple Quicktime format. When the screen illustrated in FIG. 2B is displayed, associated video (with audio) may begin to play in the digital video window 212. Alternatively, the student may press a “play” button in the window 212 to begin playing the video. The student may press a “pause” button in the video window 212 to pause the video. Furthermore, the student may drag a slider in the video window 212 to repeat any portion of the video. In the example shown in FIG. 2B, the video shows the course's primary faculty member describing the course's educational model and learning objective, as described above with respect to step 102b of FIG. 1.

Referring to FIG. 2C, the next slide in the course is shown. The slide includes a title 214 (in this example, “Expert Witness”), an audio control 216, a graphic 218, and descriptive text 220. When the slide is displayed, associated audio may begin to play. The audio may be a spoken version of the descriptive text, and may be controlled using the audio control 216. The graphic 218 may further illustrate the topic of the slide or may be provided for aesthetic purposes. The descriptive text 220 and associated audio provide a mini-lecture on a specific topic (in this case, expert witnesses), and thereby perform the role of step 102c in FIG. 1.

Referring to FIG. 2D, the next slide in the course is shown. The slide includes two graphics 222a-b (photographs, in this example), an audio control 224, and associated text 226. The various elements of the slide complement each other. In the example shown in FIG. 2D, the graphics 222a-b show participants in an expert witness examination (along with the primary faculty member), the associated audio is the speech of the primary faculty member describing the purpose of an expert witness examination, and the text 226 is a transcript of the primary faculty member's speech. If the transcript is too large to be shown in the allotted space, the student may scroll up and down to view more of the transcript. The slide shown in FIG. 2D therefore represents part of a specific topic demonstration with commentary and therefore performs the role of step 102d in FIG. 1.

Referring to FIG. 2E, the next slide in the course is shown. The slide includes one graphic 228 (a photograph, in this example), an audio control 230, and associated text 232. In the example shown in FIG. 2E, the graphic 228 shows participants in an expert witness direct examination (including the expert witness, examining attorney, jurors, stenographer, and opposing counsel) and the associated text is a description of the topics typically included in expert witness testimony. The associated text includes text 234 with a hyperlink to an associated pathway. The hyperlinked text 234 therefore partially performs the role of the link 104c described above with respect to FIG. 1.

If the student chooses to follow the link (such as by clicking on the text 234), the slide shown in FIG. 2F may be displayed. This slide provides information about the chosen pathway, which in this case is a pathway to comments by an expert other than the primary faculty member. The slide includes a title 236 summarizing the chosen pathway, a graphic 238 showing the commenting expert, and associated text 240 providing the expert's comments. This slide therefore partially performs the role of the link 104c described above with respect to FIG. 1. When the student is finished absorbing the information provided in the slide, the student may click on a special forward button 244 to display the next slide in the main learning highway (i.e., the slide shown in FIG. 2G), or click on a special backward button 242 to display the previous slide in the main learning highway (i.e., the slide shown in FIG. 2F).

The next slide in the main learning highway is shown in FIG. 2G, which includes text 246 quoting primary reference material (in this example, Federal Rule of Evidence 705), additional text 248 describing the primary reference material, and an audio control 250 corresponding to associated audio (which may, for example, be a spoken version of the text 246 and 248). The slide shown in FIG. 2G may play the role of pathway 104d in FIG. 1.

The text 248 includes text 252 with a hyperlink to secondary reference materials (in this case, the Advisory Committee Notes to Federal Rule of Evidence 705). If the student is interested in the secondary reference materials, the student may click on the hyperlinked text 252, causing the secondary materials 254 to be displayed, as shown in FIG. 2H. Note that in this example, the secondary materials 254 are stored in a separate file and displayed by a separate application program (in this example, Microsoft Word). The hyperlinked text 252 and associated secondary materials 254 thereby play the role of pathway 104e in FIG. 1.

The next slide in the main learning highway 102 is shown in FIG. 2I, which includes graphics 256a-c, audio control 258, and associated text 260. In the example shown in FIG. 2I, the graphic 228 shows the primary faculty member and participants in an expert witness direct examination, and the associated text is a transcript of the primary faculty member's speech. The speech and transcript text 260 provide an introduction to two demonstrations of expert witness direct examinations. The slide shown in FIG. 2I therefore partially plays the role of element 102d in the main learning highway in FIG. 1.

Referring to FIG. 2J, the next slide in the main learning highway 102 is shown. The slide includes graphics 262a-b showing participants (e.g., the judge and examining attorney) in an expert witness direct examination, an audio control 264, and associated text 266a. The text 266a may be a transcript of the direct examination, which is played when the slide is displayed. The slide shown in FIG. 2J is an example of a specific topic demonstration that partially plays the role of element 102d in FIG. 1. The slide shown in FIG. 2K, which includes graphics 268a-c and associated text 266b, is a continuation of the slide shown in FIG. 2J.

Referring to FIG. 2L, the next slide in the main learning highway 102 is shown. The slide includes graphics 268a-b showing the main faculty member and associated text representing commentary by the main faculty member on the first demonstration. This slide therefore partially plays the role of element 102d in the main learning highway.

Referring to FIG. 2M, the next slide in the main learning highway 102 is shown. The slide includes graphics 272a-c showing participants in a demonstration of an expert witness direction examination, associated text 276s (the transcript of the demonstration), and an audio control 274 (for controlling playback of audio from the demonstration). This slide therefore plays part of the role of element 102d in FIG. 1. The slide shown in FIG. 2N, which includes graphics 272d-f and associated text 276b, is a continuation of the slide shown in FIG. 2M.

The next slide in the main learning highway 102, shown in FIG. 20, includes graphics 278a-b showing the primary faculty member and participants in the first demonstration, associated text 282 (the transcript of the primary faculty member's speech), and an audio control 274 (for controlling playback of the primary faculty member's commentary). In this slide, the primary faculty member comments on the first demonstration represented by the previous set of slides. This slide therefore partially plays the role of element 102d in FIG. 1. FIGS. 2P and 2Q, which include graphics 284a-b, audio controls 286a-b, and associated text 288a-b, are continuations of FIG. 20.

The next slide in the main learning highway 102, shown in FIG. 2R, includes graphics 290a-b showing the primary faculty member and participants in the second demonstration, associated text 294 (the transcript of the primary faculty member's speech), and an audio control 292 (for controlling playback of the primary faculty member's commentary). In this slide, the primary faculty member comments on the first demonstration, introduces the second demonstration, and quotes from relevant primary source material (in this example, the Federal Rules of Evidence). This slide therefore partially plays the role of element 102d in the main learning highway and element 104g in FIG. 1.

Referring to FIG. 2S, the next slide in the main learning highway 102 is shown. The slide includes graphics 296a-c showing participants (e.g., the judge and examining attorney) in a second demonstration of an expert witness direct examination, an audio control 298, and associated text 300. The text 300 may be a transcript of the direct examination, which is played when the slide is displayed. The slide shown in FIG. 2S is an example of a specific topic demonstration that partially plays the role of element 102d in FIG. 1.

Referring to FIG. 2T, the next slide in the main learning highway 102 is shown. The slide includes graphic 304 showing the primary faculty member, associated text 306 representing commentary by the main faculty member on the second demonstration, and an audio control 304 for controlling audio representing the speech of the primary faculty member. This slide therefore partially plays the role of element 102d in the main learning highway. If the commentary in FIG. 2T were instead provided by another expert, then the slide shown in FIG. 2T could play the role of element 104f in FIG. 1.

Referring to FIG. 2U, the next slide in the main learning highway 102 is shown. This slide includes graphic 308 showing participants in the second demonstration (e.g., examining attorney, expert witness, and judge from the perspective of the jury), associated text 312 introducing the next segment of the expert witness' testimony and explaining its purpose, and an audio control 310 for controlling playback of associated audio corresponding to the text 312. The slide in FIG. 2U therefore partially plays the role of element 102d in FIG. 1.

Referring to FIG. 2V, the next slide is shown. This slide includes text 314 of primary reference material (Federal Rule of Evidence 703 in this example), a graphic 318 showing the primary faculty member, a transcript 320 of the primary faculty member explaining the text 314 of the primary reference material, and an audio control 316 for controlling the playback of the primary faculty member's speech. This slide therefore plays the role of pathway 104g in FIG. 1.

Referring to FIG. 2W, the next slide in the main learning highway 102 is shown. The slide includes graphics 322a-c showing participants (e.g., the examining attorney, expert witness, and judge from the perspective of the jury) in the second demonstration, an audio control 326, and associated text 324. The text 324 may be a transcript of the direct examination, which is played when the slide is displayed. The slide shown in FIG. 2W is an example of a specific topic demonstration that partially plays the role of element 102d in FIG. 1.

Referring to FIG. 2X, the next slide in the main learning highway is shown. The slide includes a video window 328 in which a video of the primary faculty member is played when the slide is displayed. In the video, the primary faculty member provides a wrap up of the lesson taught in the preceding course. This slide therefore performs the function of element 102e in the main learning highway 102 shown in FIG. 1.

The embodiment illustrated and described above with respect to FIG. 2 is merely an example. Embodiments of the present invention may be implemented in other ways. For example, the example illustrated in FIG. 2 may use other kinds of audiovisual elements (e.g., full-motion video instead of still photos) and may be applied to topics other than legal practice.

The audiovisual elements in a course such as that illustrated in FIG. 2 may be selectively enabled to provide the student with different perspectives. For example, if it is desired that the student learn from the perspective of a juror, then the course may present the student with images of the courtroom from the perspective of a juror and provide the student only with information that would be made available to a juror, such as the trial testimony and transcript, but not information that would be available only to an examining attorney, such as the attorney's notes. If it is desired that the student learn from the perspective of an attorney, then the course may present the student with images of the courtroom from the perspective of an attorney (including, for example, images of the jury and of privileged materials), but not information that would be available only to the judge, jurors, or opposing attorney. The student may be given the power to change his or her perspective. Alternatively, the teacher may pre-select the student's perspective for a particular pedagogical purpose. For example, the teacher may put one student in the virtual “seat” of the judge, one in the “seat” of each of the attorneys, and twelve students in the “seats” of the jurors. The teacher may also allow the students to change perspectives (roles) mid-course in order to learn from different perspectives.

Similarly, an particular mode of communication in the course—such as text, audio, or video—may be disabled. For example, the audio and video may be disabled so that all information is provided in textual form to the students. Alternatively, for example, text may be disabled so that the students receive all information in the form of audio and video, more closely resembling a real trial.

Similar techniques may be used to provide the course in the form of a game, which may be distributed over a network. For example, students at different network nodes may access a virtual trial online. Different students may view the trial from different perspectives (e.g., juror, judge, attorney, witness). Students may participate in the game in different ways depending on their roles. For example, a student playing the role of examining attorney may examine a witness by speaking into a microphone and/or video camera connected to the network. Live audio/video of the student may be transmitted to other students playing the game. Similarly, the student attorneys may see and hear the testimony of the witnesses online, and see the reactions of the judge and jurors. In short, the game may provide an online virtual courtroom in which the actions of all participants are captured and transmitted to the other participants. Such a game may be played for entertainment and/or training purposes. Such a game may be combined with any of the features described above (such as commentary by experts and selective enablement of audio and video) to enhance the educational and/or entertainment value of the game.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

The description above may refer to certain information being provided on a computer-readable medium, such as a CD or DVD. Such information may be provided, alternatively or additionally, over a computer network, such as the public Internet or a private intranet. Furthermore, such information need not be pre-generated and stored, but may be transmitted to the student based on one or more live performances.

Although the description above may refer to applying certain teaching and learning methods to particular areas of law, the techniques disclosed herein are not limited to teaching those particular areas of law, and may be used to teach topics other than law.

The techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

What is claimed is:

1. A method comprising:
(A) identifying a course of instruction including a plurality of instructional components having a default sequence of presentation;
(B) providing at least some of the plurality of instructional components to a student in a particular sequence of presentation;
(C) receiving input from the student in response to the at least some of the plurality of instructional components;
(D) identifying, based at least in part on input from a faculty member, a measure of performance of the student based on the received input; and
(E) providing the student with an indication of the measure of performance.

2. The method of claim 1, wherein (C) comprises receiving the input from the student at predetermined times during the particular sequence of presentation.

3. The method of claim 1, wherein (A) comprises identifying the course of instruction from information tangibly stored on a computer-readable medium, and wherein (B) comprises providing the at least some of the plurality of instructional components to the student by read at least some of the information stored on the computer-readable medium.

4. The method of claim 1, wherein (D) and (E) are performed after completion of (B) and (C).

5. The method of claim 1, wherein the particular sequence of presentation is the same as the default sequence of presentation.

6. The method of claim 1, further comprising:
(F) receiving, from the student, input selecting a link to other information related to a particular one of the plurality of instructional components; and
(G) in response to the input selecting the link, providing the other information to the student.

7. The method of claim 1, wherein (B) comprises playing an audio stream to the student.

8. The method of claim 7, wherein (B) further comprises displaying a transcript of the audio stream to the student.

9. The method of claim 1, wherein (B) comprises displaying an image to the student.

10. The method of claim 1, wherein (B) comprises:
(B)(1) receiving component-selecting input from the student selecting a particular one of the plurality of instructional components; and
(B)(2) providing the particular one of the plurality of instructional components to the student in response to the component-selecting input provided in (B)(1).

11. A computer-implemented method comprising:
(A) providing at least two of a text stream, an audio stream, and a video stream to a user to provide the user with output representative of a first role; and
(B) disabling one of the text stream, the audio stream, and the video stream to provide the user with output representative of a second role that differs from the first role.

12. The method of claim 11, further comprising:
(C) before (B), receiving input from the user; and
wherein (B) is performed in response to the input received in (C).

13. The method of claim 11, wherein (B) comprises disabling the audio stream.

14. The method of claim 11, wherein (B) comprises disabling the text stream.

15. A computer-implemented method comprising:
(A) providing a plurality of users with output representing a trial;
(B) receiving first input from a first one of the plurality of users, the first input representing a question;
(C) providing the question to a second one and a third one of the plurality of users;
(D) receiving second input from the second one of the plurality of users, the second input representing an answer to the question; and
(E) providing the answer to the first, second, and third ones of the plurality of users.

16. A computer-implemented system comprising:
means for identifying a course of instruction including a plurality of instructional components having a default sequence of presentation;
means for providing at least some of the plurality of instructional components to a student in a particular sequence of presentation;
means for receiving input from the student in response to the at least some of the plurality of instructional components;
means for identifying, based at least in part on input from a faculty member, a measure of performance of the student based on the received input; and
means for providing the student with an indication of the measure of performance.

17. A computer-implemented system comprising:
means for providing at least two of a text stream, an audio stream, and a video stream to a user to provide the user with output representative of a first role; and
means for disabling one of the text stream, the audio stream, and the video stream to provide the user with output representative of a second role that differs from the first role.

18. A computer-implemented method comprising:
(A) providing a plurality of users in communication over a computer network with output representing a trial;
(B) receiving first input from a first one of the plurality of users, the first input representing a reaction to an event in the trial; and
(C) storing a tangible record of the first input in a computer-readable medium.

19. A computer-implemented system comprising:
means for providing a plurality of users in communication over a computer network with output representing a trial;
means for receiving first input from a first one of the plurality of users, the first input representing a reaction to an event in the trial; and
means for storing a tangible record of the first input in a computer-readable medium.
